(19) United States
(12) Patent Application Publication
(10) Pub. No.: US 2023/0006186 A1
(43) Pub. Date: Jan. 5, 2023

(54) METHOD FOR PRE-LITHIATING AN ANODE

(71) Applicant: Beyonder AS, Sandnes (NO)

(72) Inventor: Fengliu Lou, Stavanger (NO)

(73) Assignee: Beyonder AS, Sandnes (NO)

(21) Appl. No.: 17/779,421

(22) PCT Filed: Dec. 3, 2020
(86) PCT No.: PCT/NO2020/050297

§ 371 Date: May 24, 2022

(30) Foreign Application Priority Data
Dec. 5, 2019 (NO) 20191439

(51) Int. Cl. H01M 4/04; H01M 4/38; H01M 10/0583; H01M 10/0587; H01M 50/46

(52) U.S. Cl. CPC H01M 4/0445; H01M 4/0459; H01M 4/382; H01M 10/0583; H01M 10/0587; H01M 50/46; H01M 2004/027

(57) ABSTRACT

Method for pre-lithiating an anode, wherein the method comprises the steps of: packing an anode sheet with a lithium-comprising sheet as a jelly roll or stack in an electrolyte; transferring lithium ions to the anode sheet to obtain a pre-lithiated anode sheet by direct contact between the anode sheet and the lithium-comprising sheet or by discharging or charging the anode sheet towards the lithium-comprising sheet; and dividing the pre-lithiated anode sheet into a plurality of pre-lithiated anodes of a desired size and shape. The invention further relates to an electrochemical cell comprising an an-ode which is pre-lithiated by the method.

### CROSS-REFERENCE TO RELATED APPLICATIONS

This application is the U.S. national stage application of International Application PCT/NO2020/050297, filed Dec. 3, 2020, which international application was published on Jun. 10, 2021, as International Publication WO 2021/112686 in the English language. The International Application claims priority of Norwegian Patent Application No. 20191439, filed Dec. 5, 2019. The international application and Norwegian application are both incorporated herein by reference, in entirety.

### FIELD

The invention relates to a method for pre-lithiating an anode and to an electrochemical cell comprising an anode which is pre-lithiated by the method.

### BACKGROUND

Pre-lithiation of the anode in electrochemical cells which uses lithium ions is often performed to increase the performance of the cell. Lithium metal is the most widely used lithium source for anode pre-lithiation, despite its high cost and risk. The technology can be divided into two categories depending on whether the lithium serves as a third electrode, or whether it is coated directly on the surface of the anode. When a lithium foil is utilized as third electrode, a long pre-lithiation period up to 20 days is needed to obtain a satisfactory degree of lithiation of the anode (U.S. Pat. Nos. 6,461,769 and 6,740,454). This not only increases the production cost, but also limits the productivity. Additionally, a porous current collector is also needed for penetrating the lithium ions, which further increases production cost. On the other hand, various methods have been developed for lithium coating on the surface of the anode, such as physical vapor deposition, melt lithium coating, ultrathin lithium foil pressing, and stabilized lithium metal powder. However, these methods suffer from poor flexibility and pre-lithiation uniformity in addition to high cost (US20170324073A1 and ECS Transactions, 2007. 3(27):15).

There are other pre-lithiation methods, such as electrochemical pre-lithiation and internal short-circuit pre-lithiation, which have been extensively explored and utilized in the academic community, but which are believed unpractical for industrial application. The main obstacle with these methods is that it is not practical to assemble every cell only for pre-lithiation of the anode, and then disassemble them again before the final cell assembly. US 2016141596 A1, US 2013003261 A1, KR 20150014877 A, WO 2017100415 A1, and CN 110335992 A disclose a variety of methods for lithiating electrodes.

### SUMMARY

The invention has for its object to remedy or to reduce at least one of the drawbacks of the prior art, or at least provide a useful alternative to prior art. The object is achieved through features, which are specified in the description below and in the claims that follow. The invention is defined by the independent patent claims, while the dependent claims define advantageous embodiments of the invention.

In a first aspect, the invention relates more specifically to a method for pre-lithiating a plurality of anodes, wherein the method comprises the steps of: packing an anode sheet with a lithium-comprising sheet and a separator as a jelly roll or stack in an electrolyte, wherein the lithium-comprising sheet comprises a compound which can provide lithium ions; transferring lithium ions to the anode sheet to obtain a pre-lithiated anode sheet by discharging or charging the anode sheet towards the lithium-comprising sheet; and dividing the pre-lithiated anode sheet into a plurality of pre-lithiated anodes of a desired size and shape.

The lithium-comprising sheet should be able to provide lithium ions to the electrolyte for pre-lithiation of the anode. In a currently non-claimed embodiment, the lithium-comprising sheet may be a lithium foil, but it may also be a sheet of another material which comprises lithium, for example a copper foil coated with lithium. The lithium-comprising sheet that comprises a compound which can provide lithium ions, for example comprises lithium cobalt oxide, lithium manganese oxide, lithium nickel manganese cobalt oxide, lithium iron phosphate, lithium titanium oxide, lithium azide, lithium squarate, lithium oxalate, lithium ketomalonate, or lithium di-ketosuccinate. The sheets may be shaped as very long strips which can be rolled around a suitable core to form a jelly roll. Alternatively, the strips may be Z-stacked, or a plurality of anode sheets and lithium-comprising sheets may be stacked on top of each other. In this way the sheets will have a large surface area close to each other to reduce the distance that the lithium ions are required to diffuse through the electrolyte, thereby increasing the efficiency of the method by decreasing the time required to pre-lithiate the anode sheet. Packing of the anode sheet and lithium-comprising sheet in an electrolyte means that electrolyte should be present before the next step in the method, i.e. jelly roll or stack may be assembled before or after addition of electrolyte. A layer of separator is placed between the anode sheet and the lithium-comprising, in which case the anode sheet is discharged towards the lithium-comprising sheet for the lithium ions to be transferred. The pre-lithiated anode sheet may typically be washed with a suitable solvent before it is divided, typically by cutting or slitting.

The process of producing an electrochemical cell typically includes mixing of the electrode components, coating the resulting electrode slurry on a metal foil before drying, calendaring of the electrode to densify and enhance its adhesion onto the metal foil, slitting/cutting the electrode into suitable sizes, pre-lithiating of each of the anodes, and finally cell assembly and formation steps.

An advantage of using the method according to the invention is that, instead of packing each of a plurality of anodes together with an individual lithium foil into individual cells for pre-lithiation of each anode as in prior art, a larger anode sheet can be packed in a larger cell with a correspondingly large lithium-comprising sheet. The anode sheet may for large scale production be e.g. 0.01-2 m wide and 1-1000 m long. The size and shape of the anode sheet may depend on the packing of the anode sheet in the electrolyte. If packed as a jelly roll, the anode sheet may be very long, for example 1 m wide and 1000 m long. After the pre-lithiated anode sheet has been divided, each pre-lithiated anode obtained by the method can then be packed with a suitable cathode, separator, and electrolyte to produce an electrochemical cell, e.g. a lithium-ion battery or lithium-ion capacitor. This will significantly reduce the number of cells required for pre-lithiation, which reduces the complexity of the process and making it industrially applicable for largescale production. Additionally, the method has the advantages of high flexibility and precise control of the degree of pre-lithiation.

In one embodiment, the step of packing the anode sheet with the lithium-comprising sheet as a jelly roll or stack in the electrolyte may include the step of subjecting the anode sheet and lithium-comprising sheet to the electrolyte before assembling a jelly roll or stack of the anode sheet and lithium-comprising sheet. This ensures a high wettability of the sheets, i.e. that the electrolyte covers all areas of the sheets, or at least has a larger contact surface with the sheets. The sheets may for example be immersed in the electrolyte while they are assembled as a jelly roll or a stack. If the jelly roll or stack are assembled before being subjected to the electrolyte, the close contact of the anode sheet and lithium-comprising sheet may prevent the electrolyte accessing some regions between the sheets, or at least increase the time it takes for the electrolyte to access these regions. This problem may be more pronounced for a larger stack or jelly roll. A suitable separator between the anode sheet and the lithium-comprising sheet may also increase the rate and/or degree of wettability of the sheets. A suitable separator may for example comprise a microporous, polymeric membrane.

As the step of transferring lithium ions to the anode sheet to obtain a pre-lithiated anode sheet includes the step of discharging the anode sheet towards the lithium-comprising sheet, this will provide a driving force for the positively charged lithium ions to be transferred to the anode sheet. This step may be performed by connecting the anode sheet and lithium-comprising sheet to a battery analyzer. The step of transferring lithium ions to the anode sheet to obtain a pre-lithiated anode sheet may also include the step of applying a pre-defined charge or discharge protocol between the anode sheet and the lithium-comprising sheet. In this way, the pre-lithiation degree can be precisely controlled. Additionally, the properties of solid electrolyte interface can be optimized and controlled by controlling the current and charge and discharge protocol as well as the temperature and pressure. This provides a high flexibility of the method. As an alternative to the battery analyzer, a resistor with a predetermined resistance may be used to achieve a similar effect.

In one embodiment, the method may additionally comprise the step of masking a predetermined area of the anode sheet with a layer of polymer film before the step of packing the anode sheet with the lithium-comprising sheet in the electrolyte. A current collector area for connection with a metal tab is generally required on the anode for connecting it with an external circuit, and this tab area will be contaminated by the electrolyte during the pre-lithiation process. By masking the tab area with a layer of polymer film, such as polyethylene (PE) or polypropylene (PP), and remove this film after pre-lithiation, contamination of the tab area may be prevented or mitigated. The current collector area can be washed by organic solvent, such as dimethyl carbonate (DMC) or diethyl carbonate (DEC), or laser, to ensure its high welding quality with the metal tab.

In one embodiment, the step of transferring lithium ions to the anode sheet to obtain a pre-lithiated anode sheet may be enhanced by pressing the jelly roll through an external fixture. This will ensure a uniform distance between anode and lithium foil thus improving the pre-lithiation uniformity. Additionally, since gas may be generated during the pre-lithiation process, which may form gas bubbles and affect the pre-lithiation uniformity, application of an increased external pressure may facilitate gas transportation away from the electrode surface. The external pressure applied can be up to 1 MPa, for example 0.1, 0.5, or 1 MPa.

In one embodiment, the step of packing the anode sheet with the lithium-comprising sheet in the electrolyte includes rolling the anode sheet and lithium-comprising sheet around a large core to decrease the curvature of the anode sheet. The core may for example have a diameter of 5, 25, 50, or 100 cm, or whatever value is practically suitable. The larger the core, the smaller the curvature. In this way bending of the pre-lithiated anode due to volume expansion during the pre-lithiation process will be less severe. Alternative ways for decreasing the bending is to Z-stack the anode sheet and the lithium-comprising sheet, alternately stack a plurality of large sheets, or use a jelly roll core with at least one flat surface to provide a region of the anode that is flat when wounded around the core.

In a second aspect the invention relates to an electrochemical cell, wherein the electrochemical cell comprises an anode which is pre-lithiated by the method according to the first aspect of the invention. The electrochemical cell may for example be a lithium-ion capacitor or a lithium-ion battery.

### BRIEF DESCRIPTION OF THE DRAWINGS

In the following is described examples of preferred embodiments illustrated in the accompanying drawings, wherein:

FIG. 1 shows a preparation of an anode sheet and a lithium-comprising sheet as a cylindrical jelly roll (FIG. 1a, viewed from along the cylinder axis), and packing of the wound jelly roll in a container with an electrolyte (FIG. 1b, viewed perpendicularly to the cylinder axis);

FIG. 2 shows another preparation of an anode sheet and a lithium-comprising sheet as a rectangular jelly roll (FIG. 2a, viewed along the axis of rotation of the jelly roll), and packing of the jelly roll in an electrolyte (FIG. 2b, viewed perpendicular to the view in FIG. 1a) while attached to a battery analyzer;

FIG. 3 shows additional ways in which the anode sheet and lithium-comprising sheet can be packed (FIGS. 3a and b);

FIG. 4 shows a flow diagram of an embodiment of the method according to the invention;

FIG. 5 shows the cyclic stability of the lithium-ion capacitor created in example 1, by cycling between 2 and 3.8 V at a current of 7 A; and

FIG. 6 shows the charge and discharge voltage profile of the lithium-ion capacitor created in example 1, by cycling between 2 and 3.8 V at a current of 7 A.

### DETAILED DESCRIPTION OF THE DRAWINGS

In the drawings, the reference numeral 1 indicates an anode sheet. The drawings are illustrated in a schematic manner, and the features therein are not necessarily drawn to scale.

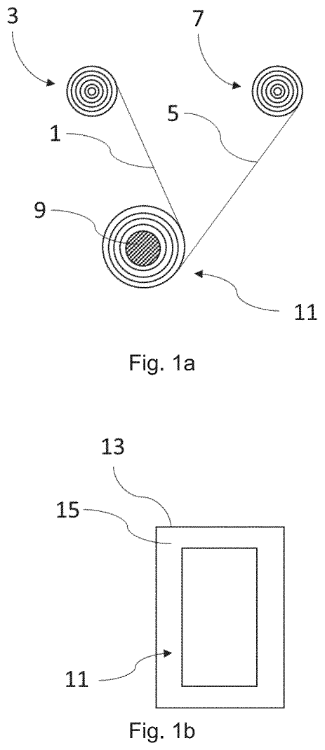

FIG. 1a shows a currently non-claimed embodiment in which an elongated anode sheet 1 as an anode sheet roll 3 and an elongated lithium-comprising sheet 5 as a lithium-comprising sheet roll 7 which are being rolled around a cylindrical jelly roll core 9 to form a jelly roll 11. The cylindrical jelly roll 11 is viewed along the cylinder axis. In the jelly roll 11, each side of the anode sheet 1 will be in contact with the lithium-comprising sheet 5. The lithium-comprising sheet 5 may in certain embodiments be e.g. lithium foil or a copper foil coated with lithium. In FIG. 1b, the jelly roll 11 from FIG. 1a (viewed perpendicularly to the view in FIG. 1a) has been immersed into a container 13 comprising electrolyte 15 to allow lithium ions to be transferred to the anode sheet 1. Since the anode sheet 1 and lithium-comprising sheet 5 are in direct contact, electrons may be transferred between the anode sheet 1 and lithium-comprising sheet 5, whereby the lithium metal in the lithium-comprising sheet 5 may be oxidized and release lithium ions into the electrolyte 15 and onto the anode sheet 1.

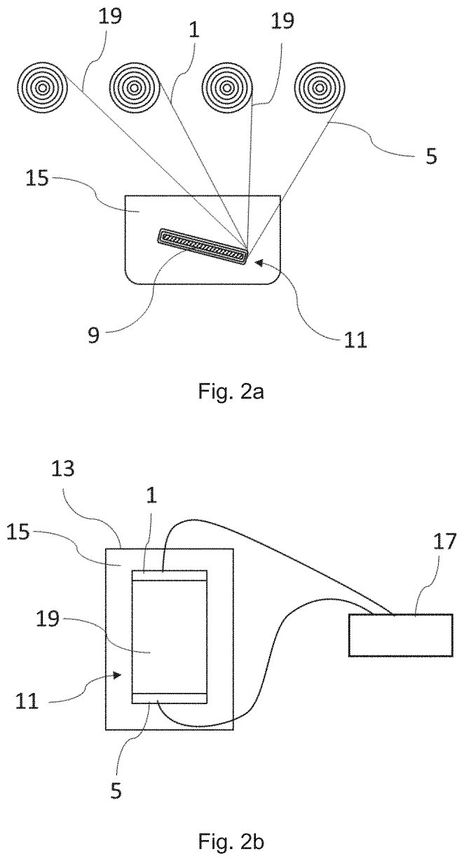

FIG. 2 shows another way of packing the anode sheet 1 and lithium-comprising sheet 5. In FIG. 2a, two sheets of separator 19 are placed between the anode sheet 1 and lithium-comprising sheet 5 as they are wound around a rectangular core 9 to form a jelly roll 11. The separator sheets 19 provide an electrical insulation between the anode sheet 1 and the lithium-comprising sheet 5. In this way, a battery analyzer 17 can be connected to the anode sheet 1 and the lithium-comprising sheet 5 as shown in FIG. 2b (viewed perpendicularly to the view in FIG. 2a) to allow a charge and discharge protocol to be applied. The anode sheet 1 and lithium-comprising sheet 5 are extending from each side of the separator 19 to allow connection with the battery analyzer 17. The separator 19 may additionally increase the wettability of the electrolyte on the anode sheet 1 and lithium-comprising sheet 5. To increase the wettability even further, the sheets 1,5,19 are wound into the jelly roll 11 while immersed in electrolyte 15. Since the core 9 of the jelly roll 11 is relatively flat, the regions of the anode sheet 1 which are parallel to the largest surfaces of the core 9 are also flat.

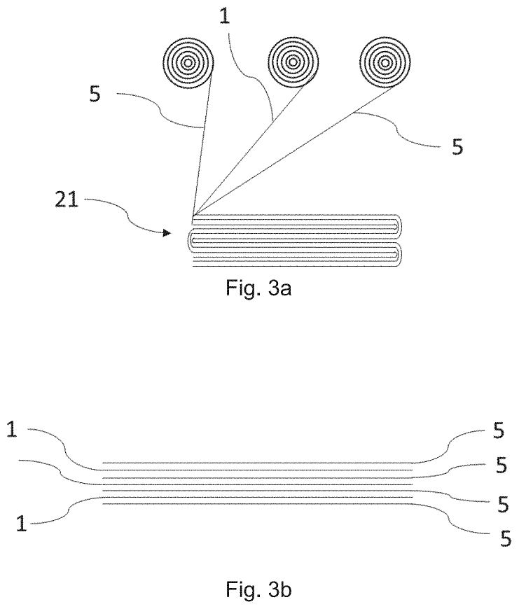

FIG. 3 shows other ways of packing the anode sheet 1 for obtaining flat regions of the anode sheet 1. For example, as shown in FIG. 3a, the anode sheet 1 may be packed between lithium-comprising sheets 5 as a Z-stack 21, or a plurality of large anode sheets 1 and lithium-comprising sheets 5 may be stacked alternately as shown in FIG. 3b.

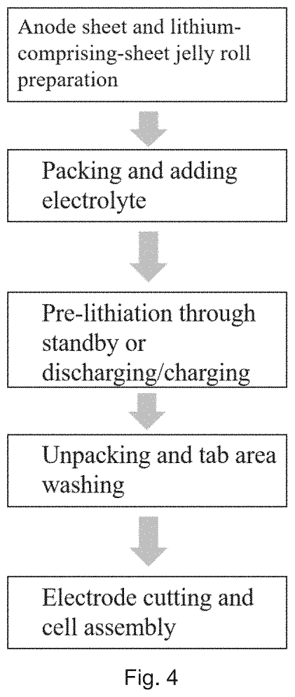

FIG. 4 shows a flow diagram of an embodiment of the method according to the invention. In the first step, a jelly roll is prepared from an elongated anode sheet and lithium-comprising sheets. In the next step, the jelly roll is packed inside a container, and electrolyte is added. Pre-lithiation of the anode sheet is then performed by discharging/charging. After this step, the pre-lithiated anode sheet is unpacked, and the tab areas for electrical connection are washed. Finally, the pre-lithiated anode sheet is cut into a plurality of pre-lithiated anodes, which are then used as anodes in a plurality of cells.

In the following is described six examples of embodiments of the method according to the invention.

In the examples 1, 2, 5, and 6 graphite electrodes as anode sheets were produced by industrial scale slot die coating of commercially available graphite (BFC-18™ purchased from BTR, China) on copper foil. Carboxymethylcellulose (CMC) and styrene-butadiene rubber (SBR) were utilized as binder while the Carbon Black Timcal Super C65™ and Imerys graphite SFG-6L™ were employed as conductive additive. The mass ratio of graphite:CMC:SBR:Super C65™:SFG-6L™ was 90:1.5:3.5:3.2:1.8. A cold calendaring was followed to densify the electrode and enhance the adhesion of activated material coating layer on metal foil.

In the examples 3 to 4, silicon/carbon electrodes as anode sheets were produced by industrial scale slot die coating of commercially available silicon/carbon composite (S-600™ purchased from BTR, China) on copper foil. Carboxymethylcellulose (CMC) and styrene-butadiene rubber (SBR) were utilized as binder while Timcal Super C65™ and Imerys graphite SFG-6L™ were employed as conductive additive. The mass ratio of graphite:CMC:SBR:Super C65™:SFG-6L™ was 90:1.5:3.5:3.2:1.8. A cold calendaring was followed to densify the electrode and enhance the adhesion of activated material coating layer on metal foil.

In the examples 1, 2, 3, 5, and 6 activated carbon electrodes as cathodes were produced by industrial-scale slot die coating of commercially available activated carbon (YEC-8B™ purchased from Fujian Yihuan, China) on etched aluminum foil. Carboxymethylcellulose (CMC) and Styrene-butadiene rubber (SBR) were utilized as binder while Timcal Super C65™ was employed as conductive additive. The mass ratio of activated carbon:CMC:SBR:Super C65™ was 86.5:1.5:4.0:8.0. A cold calendaring was followed to densify the electrode and enhance the adhesion of the activated coating layer on the metal foil.

In the example 4, lithium nickel manganese cobalt oxide (NMC) electrode as cathode was produced by industrial scale slot die coating of commercially available NMC on aluminum foil. Polyvinylidene difluoride (PVdF) was utilized as binder while Timcal Super C65™ was employed as conductive additive. The mass ratio of NMC:PVdF:Super C65™ was 88:8:4. A cold calendaring was followed to densify the electrode and enhance the adhesion of activated material coating layer on metal foil.

In the example 5, lithium iron phosphate (LFP) electrode as cathode was produced by industrial scale slot die coating of commercially available LFP on aluminum foil. Polyvinylidene difluoride (PVdF) was utilized as binder while Timcal Super C65™ was employed as conductive additive. The mass ratio of NMC:PVdF:Super C65™ was 88:8:4. A cold calendaring was followed to densify the electrode and enhance the adhesion of activated material coating layer on metal foil.

In the example 6, lithium squarate electrode was produced by a lab doctor blade coating method of commercially available lithium squarate on aluminum foil. Polyvinylidene difluoride (PVdF) was utilized as binder while Timcal Super C65™ was employed as conductive additive. The mass ratio of NMC:PVdF:Super C65™ was 60:8:32. A cold calendaring was followed to densify the electrode and enhance the adhesion of activated material coating layer on metal foil.

### Example 1

This example is not part of the claimed invention. A double-sided coated graphite electrode as an anode sheet was slit into 90 mm width with 15 mm uncoated area on one side. 2 m long anode sheet and 2 m long lithium foil were wound into a jelly roll. The roll was inserted into a laminated aluminum foil bag. Sufficient electrolyte to impregnate the jelly roll was added before sealing of the bag. The roll was rested for 2 hours and then pressure was applied on the roll for 22 hours through a fixture. The bag was then opened, and the roll was unwound. A golden-colored pre-lithiated anode sheet was obtained. The uncoated tab area was then rinsed with dimethyl carbonate after the pre-lithiated anode sheet was dried. The pre-lithiated anode sheet was cut into a size of 59 by 81 mm. 11 pieces of pre-lithiated anode and 10 pieces of active carbon electrodes were stacked with a layer of separator in between. Then an aluminum tab and a nickel tab were welded ultrasonically onto the cathode and pre-lithiated anode, respective, before packing the stack inside of a laminated aluminum case. Electrolyte was added before final heat sealing.

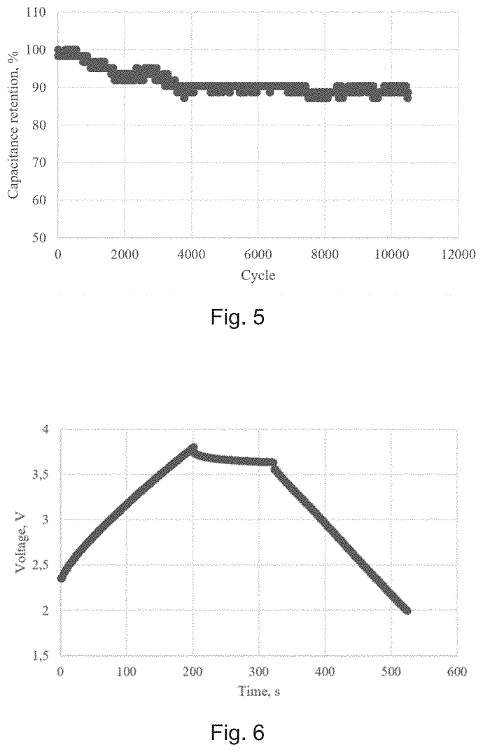

The cyclic stability of the created lithium-ion capacitor by cycling between 2 and 3.8 V at a current of 7 A is shown in FIG. 5, and the charge and discharge voltage profile is shown in FIG. 6. There was a 2 min reset between charge and discharge.

### Example 2

A double-sided coated graphite electrode as an anode sheet was slit into 90 mm width with 15 mm uncoated area on one side. 2 m long anode sheet and 2 m long lithium foil were wound into a jelly roll with a layer of separator in between. The roll was inserted into a laminated aluminum foil bag. Sufficient electrolyte to impregnate the jelly roll was added before sealing of the bag. The roll was rested for 2 hours. A cable wire was connected to the anode sheet and lithium foil electrode, respectively, to achieve an external short circuit for 22 hours. The bag was opened and the roll was unwound. A golden-colored pre-lithiated anode sheet was obtained. The uncoated tab area was then rinsed with dimethyl carbonate after the pre-lithiated anode sheet was dried. The pre-lithiated anode sheet was cut into a size of 59 by 81 mm. 11 pieces of pre-lithiated anode and 10 pieces of active carbon electrodes were stacked with a layer of separator in between. Then an aluminum tab and a nickel tab were ultrasonically welded onto the cathode and anode, respective, before packing the stack inside of a laminated aluminum case. Electrolyte was added before final heat sealing.

### Example 3

A double-sided coated silicon/carbon electrode as an anode sheet was slit into 90 mm width with 15 mm uncoated area on one side. 2 m long anode sheet and 2 m long lithium foil were wound into a jelly roll with a layer of separator in between. The roll was inserted into a laminated aluminum foil bag. Sufficient to impregnate the jelly roll electrolyte was added before sealing of the bag. The roll was rested for 2 hours. The roll was connected to a battery analyzer, and the anode sheet was discharged at a rate of C/10 for 8 hours to achieve the pre-lithiation. The bag was opened, and the roll was unwound. The uncoated tab area was then rinsed with dimethyl carbonate after the pre-lithiated anode sheet was dried. The pre-lithiated anode sheet was cut into a size of 59 by 81 mm. 11 pieces of pre-lithiated anodes and 10 pieces of active carbon electrodes were stacked with a layer of separator in between. Then an aluminum tab and a nickel tab were ultrasonically welded on the cathode and anode, respective, before packing the stack inside of a laminated aluminum case. Electrolyte was added before final heat sealing.

### Example 4

A double-sided coated silicon/carbon electrode as an anode sheet was slit into 90 mm width with 15 mm uncoated area on one side. 2 m long anode sheet and 2 m long lithium foil were wound into a jelly roll with a layer of separator in between. The roll was inserted into a laminated aluminum foil bag. Sufficient electrolyte to impregnate the jelly roll was added before sealing of the bag. The roll was rested for 2 hours. The roll was connected to a battery analyzer, and the anode sheet was discharged at a rate of C/10 for 1 hour to achieve the pre-lithiation. The bag was opened, and the roll was unwound. The uncoated tab area was then rinsed with dimethyl carbonate after the pre-lithiated anode sheet was dried. The pre-lithiated anode sheet was cut into a size of 59 by 81 mm. 11 pieces of pre-lithiated anodes and 10 pieces of NMC electrodes were stacked with a layer of separator in between. Then an aluminum tab and a nickel tab were ultrasonically welded on the cathode and anode, respective, before packing the stack inside of a laminated aluminum case. Electrolyte was added before final heat sealing.

### Example 5

A double-sided coated graphite electrode as an anode sheet was slit into 90 mm width with 15 mm uncoated area on one side. 100 m long anode sheet and 100 m long lithium iron phosphate were wound into a jelly roll with a layer of separator in between. The roll was inserted into a cylindrical metal container. Sufficient electrolyte to impregnate the jelly roll was added before sealing of the cap. The roll was rested for 2 hours before applying vacuum. A copper wire and Al wire were connected to the anode sheet and lithium iron phosphate electrode, respectively, to charge at 2.5 A for 20 hours. The container was opened and the roll was unwound. A golden-colored pre-lithiated anode sheet was obtained. The uncoated tab area was then rinsed with dimethyl carbonate after the pre-lithiated anode sheet was dried. The pre-lithiated anode sheet was cut into a size of 59 by 81 mm. 11 pieces of pre-lithiated anode and 10 pieces of active carbon electrodes were stacked with a layer of separator in between. Then an aluminum tab and a nickel tab were ultrasonically welded onto the cathode and anode, respective, before packing the stack inside of a laminated aluminum case. Electrolyte was added before final heat sealing.

### Example 6

A double-sided coated graphite electrode as an anode sheet was slit into 90 mm width with 15 mm uncoated area on one side. 2 m long anode sheet and 2 m long di-lithium squarate electrode were wound into a jelly roll with a layer of separator in between. The roll was inserted into a laminated aluminum foil bag. Sufficient electrolyte to impregnate the jelly roll was added before sealing of the bag. The roll was rested for 2 hours. A 0.1 A current was applied to the cell with the cutoff voltage of 4.2 V. The bag was opened and the roll was unwound. A golden-colored pre-lithiated anode sheet was obtained. The uncoated tab area was then rinsed with dimethyl carbonate after the pre-lithiated anode sheet was dried. The pre-lithiated anode sheet was cut into a size of 59 by 81 mm. 11 pieces of pre-lithiated anode and 10 pieces of active carbon electrodes were stacked with a layer of separator in between. Then an aluminum tab and a nickel tab were ultrasonically welded onto the cathode and anode, respective, before packing the stack inside of a laminated aluminum case. Electrolyte was added before final heat sealing.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A method for pre-lithiating a plurality of anodes, wherein the method comprises the steps of:
packing an anode sheet with a lithium-comprising sheet and a separator as a jelly roll or stack in an electrolyte, wherein the lithium-comprising sheet comprises a compound which can provide lithium ions;
transferring lithium ions to the anode sheet to obtain a pre-lithiated anode sheet by discharging or charging the anode sheet towards the lithium-comprising sheet; and
dividing the pre-lithiated anode sheet into a plurality of pre-lithiated anodes of a desired size and shape.

2. The method according to claim 1, wherein the step of packing the anode sheet with the lithium-comprising sheet a jelly roll or stack of the anode sheet in the electrolyte includes the step of subjecting the anode sheet and lithium-comprising sheet to the electrolyte before assembling a jelly roll or stack of the anode sheet and lithium-comprising sheet.

3. The method according to claim 1, wherein the step of transferring lithium ions to the anode sheet to obtain a pre-lithiated anode sheet includes the step of applying a pre-defined charge and discharge protocol between the anode sheet and the lithium-comprising sheet.

4. The method according to claim 1, wherein the method additionally comprises the step of masking a predetermined area of the anode sheet with a layer of polymer film before the step of packing the anode sheet with the lithium-comprising sheet in the electrolyte.

5. The method according to claim 1, wherein the step of transferring lithium ions to the anode sheet to obtain a pre-lithiated anode sheet is performed at a pressure above ambient pressure.

6. The method according to claim 1, wherein the step of packing the anode sheet with the lithium-comprising sheet in the electrolyte includes stacking the anode sheet and lithium-comprising sheet as a Z-stack.

7. The method according to claim 1, wherein the step of packing the anode sheet with the lithium-comprising sheet in the electrolyte includes rolling the anode sheet and lithium-comprising sheet around a core with a diameter of equal to or more than 5 cm.

8. The method according to claim 1, wherein the step of packing the anode sheet with the lithium-comprising sheet in the electrolyte includes rolling the anode sheet and lithium-comprising sheet around a flat core.

9. An electrochemical cell wherein the electrochemical cell comprises an anode which is pre-lithiated by the method according to claim 1.

10. The method according to claim 2, wherein the step of packing the anode sheet with the lithium-comprising sheet in the electrolyte includes rolling the anode sheet and lithium-comprising sheet around a core with a diameter of equal to or more than 5 cm.

11. The method according to claim 3, wherein the step of packing the anode sheet with the lithium-comprising sheet in the electrolyte includes rolling the anode sheet and lithium-comprising sheet around a core with a diameter of equal to or more than 5 cm.

12. The method according to claim 4, wherein the step of packing the anode sheet with the lithium-comprising sheet in the electrolyte includes rolling the anode sheet and lithium-comprising sheet around a core with a diameter of equal to or more than 5 cm.

13. The method according to claim 5, wherein the step of packing the anode sheet with the lithium-comprising sheet in the electrolyte includes rolling the anode sheet and lithium-comprising sheet around a core with a diameter of equal to or more than 5 cm.

14. The method according to claim 2, wherein the step of packing the anode sheet with the lithium-comprising sheet in the electrolyte includes rolling the anode sheet and lithium-comprising sheet around a flat core.

15. The method according to claim 3, wherein the step of packing the anode sheet with the lithium-comprising sheet in the electrolyte includes rolling the anode sheet and lithium-comprising sheet around a flat core.

16. The method according to claim 4, wherein the step of packing the anode sheet with the lithium-comprising sheet in the electrolyte includes rolling the anode sheet and lithium-comprising sheet around a flat core.

17. The method according to claim 5, wherein the step of packing the anode sheet with the lithium-comprising sheet in the electrolyte includes rolling the anode sheet and lithium-comprising sheet around a flat core.
